(19) United States
(12) Patent Application Publication
(10) Pub. No.: US 2020/0196636 A1
(43) Pub. Date: Jun. 25, 2020

(54) METHOD FOR OBTAINING A STABILISED FOOD DRINK MADE FROM FRUIT JUICE COMPRISING EXTRACTS OF MICROALGAE AND/OR CYANOBACTERIA

(71) Applicant: ALGAMA, Evry (FR)

(72) Inventors: Maxime PECQUET, Paris (FR); Thomas FELICE, Clamart (FR); Mathieu GONCALVES ALVES, Paris (FR)

(73) Assignee: ALGAMA, Evry (FR)

(21) Appl. No.: 16/615,333

(22) PCT Filed: Jun. 15, 2018
(86) PCT No.: PCT/FR2018/000173

§ 371 Date: Nov. 20, 2019

(30) Foreign Application Priority Data
Jun. 15, 2017 (FR) 1770628

(51) Int. Cl. A23L 2/44; A23L 2/58; A23L 2/02; A23L 17/60; A23L 2/84

(52) U.S. Cl. CPC A23L 2/44; A23L 2/58; A23L 2/84; A23L 17/60; A23L 2/02

(57) ABSTRACT

In the field of biomass valorization, in particular algal biomass, a method for obtaining a food drink having a long shelf life, preferably of more than 6 months, of acidic pH, preferably made from fruit juice, includes extracts of eukaryotic or prokaryotic microalgae (cyanobacteria). The stabilised food drink obtained by this method is also disclosed.

The present invention relates to the field of biomass valorisation, in particular algal biomass, and more specifically the present invention relates to a method for obtaining a food drink having a long shelf life, preferably more than 6 months, of acidic pH, preferably made from fruit juice, comprising extracts of eukaryotic or prokaryotic (cyanobacteria) microalgae, as well as the stabilised food drink obtained by this method.

In order to meet an increasing worldwide food demand, many manufacturers are resorting to alternative resources, such as microalgae. These microorganisms have great biodiversity and represent a unique biomass source. The production thereof is different from that of horticultural plants and cereal crops, grown on arable land, because they are highly area-efficient.

Grown for the past 30 years, microalgae are a fully-fledged foodstuff. In human and animal nutrition, there are two valorisation approaches: the first relates to the consumption of entire microalgae, and the second relates to the extraction, transformation and packaging of bioactive molecules derived from the microalgae. In France, only three species of microalgae have been authorised for human consumption without transformation and these have exceptional nutritional properties: spirulina or Arthrospira platensis, the green microalgae Chlorella and the diatom Odontella aurita. These microorganisms are being heralded as major elements to overcome the challenges facing the world's food supply, because of the unique protein content thereof and the reduced environmental impact of the production thereof: reduced water and energy consumption.

Over the past few years, spirulina in particular has garnered much attention from researchers and manufacturers. There is a huge market for the dried and non-transformed form thereof, which is intended to be used as a food supplement.

Because spirulina contains a large amount of interesting compounds having high added value, many researchers and manufacturers have been interested in the extraction of these compounds from this cyanobacteria. The biomolecule usually extracted from spirulina is phycocyanin (PC), a blue pigment-protein with an anti-oxidation activity, representing 20% of the weight thereof in a dry state (Vonshak, 1997). The growing interest for phycocyanin is explained in particular by the colouring effect thereof. Currently, the food colourings used in France are synthetic: patent blue V and brilliant blue; they often appear in the ingredients of sweets and drinks, etc. The patent blue V is said to cause increased hyperactivity among children and may have an allergenic potential, which is why it has recently been banned in the United States, Canada and Australia. Therefore, the use of natural colouring, in particular phycocyanin, has attracted increasing attention.

Water-soluble compounds extracted from microalgae and cyanobacteria, and in particular phycocyanin, show significant constraints in terms of integrating them in a drink with an acidic pH, such as a fruit juice, particularly when this stable drink is to be preserved for a minimum period of six months. The term “stable” is used to describe:

Physical and chemical stability of the formula, which retains the consistency and colour thereof over time,

Stability of the organoleptic characteristics of the formula, in particular by preventing the development of an alteration flora,

Health-related stability of the formula, by preventing the development of flora that is pathogenic to Man.

The main technologies currently available to drink producers implement a thermal processing system or a 0.2 micrometre filtration system.

The water-soluble compounds extracted from the microalgae and cyanobacteria are in particular phycocyanin, a molecule that has significant constraints:

It degrades in the presence of temperatures greater than 45° C.

It degrades in the presence of a pH of less than 3.8.

The more the pH of the solution decreases, the more phycocyanin becomes sensitive to heat.

The more the pH of the solution decreases, the quicker phycocyanin clogs filters with a porosity of less than 4 micrometres.

It is therefore impossible, according to the current state of the food and drink industry, to implement a standard pasteurisation or filtration process on the drink.

Thus, drinks currently available on the market that comprise phycocyanin are unable to achieve stability for a 12-month period, with bacterial development making them quickly unsuitable for consumption, or a degradation of the phycocyanin, which significantly alters the colour thereof.

In order to increase the stability of drinks thereof comprising phycocyanin, manufacturers of the food and drink industry have developed methods which include the addition of food preservatives and carbon dioxide in the drink, which reinforces the stability of the drink but makes it sparkly, which is not what many consumers prefer. There is therefore currently no method that makes it possible to obtain a drink with an acidic pH, comprising phycocyanin, that has a long shelf life, in particular at ambient temperature, and that is not sparkling.

The Applicant has developed a new method for obtaining a food drink with a long shelf life at ambient temperature, preferably of more than 6 months, preferably of more than 12 months, with an acidic pH, preferably made from fruit juice, comprising eukaryotic or prokaryotic (cyanobacteria) microalgae, and/or purified water-soluble compounds extracted from eukaryotic or prokaryotic (cyanobacteria) microalgae, such as phycocyanin, without having to add food preservatives or carbon dioxide in the food drink, the drink thus obtained therefore being still.

Thus, a first aim of the present invention relates to a method for obtaining a food drink with a long shelf life at ambient temperature, preferably of more than 6 months, preferably of more than 12 months, with an acidic pH, preferably made from fruit juice, comprising eukaryotic or prokaryotic (cyanobacteria) microalgae, and/or purified water-soluble compounds extracted from eukaryotic or prokaryotic (cyanobacteria) microalgae, characterised in that said method comprises at least
a) one step of mixing said extracts and/or water-soluble compounds with the ingredients of the drink that are sensitive to heat treatments, said mixture being maintained at a pH greater than 7,
b) one optional step of mixing the ingredients of the drink that are not sensitive to heat treatments with the ingredient or ingredients that have an acidic pH, preferably the fruit juice,
c) one step of sterilisation by microfiltration of the mixture obtained at step a)
d) one step of sterilisation by microfiltration or by heat treatment of the mixture obtained at step b) or of the ingredient with an acidic pH, preferably the fruit juice,
e) one step of homogenising the sterilised mixtures obtained at steps c) and d), said sterilised mixture obtained at step c) being preferably added prior to the sterilised mixture obtained at step d),
f) obtaining a drink with a long shelf life and an acidic pH comprising extracts of eukaryotic or prokaryotic (cyanobacteria) microalgae and/or purified water-soluble compounds extracted from eukaryotic or prokaryotic (cyanobacteria) microalgae.

In a preferred manner, at step e), the mixture of step c) is added prior to the sterilised mixture obtained at step d) in order not to immerse directly the mixture c), which is pH-sensitive, in the mixture d), which is an acidic solution. This could cause the water-soluble compounds extracted from eukaryotic or prokaryotic (cyanobacteria) microalgae to precipitate.

In a particularly preferred manner, at step e), in the case where the pH of the sterilised mixture obtained at step d) is close to that of the end drink, this sterilised mixture obtained at step d) can be added before or after the mixture of step c), as there is no longer the risk of the water-soluble compounds extracted from eukaryotic or prokaryotic (cyanobacteria) microalgae precipitating.

The term “microalgae” is used in the present invention to describe eukaryotic microalgae, that are characterised by a cell wall and a nucleus, comprising the chlorophyta, the chrysophyta and the pyrrophyta, said eukaryotic microalgae being commonly called “microalgae”, and prokaryotic microalgae, that do not have a nucleus or a cell wall, comprising the cyanophyta, hereinafter specifically referred to as “cyanobacteria”.

In a preferred manner according to the invention, the eukaryotic microalgae are selected from among the Chlorophyta, preferably among Chlorella, Nannochloropsis, Dunaliella and Euglena.

In a preferred manner according to the invention, the cyanobacteria are selected from among spirulina (Arthrospira platensis or Spirulina maxima) and AFA (Aphanizomenon Flos-aquae).

In a preferred manner according to the invention, the microalgae are cyanobacteria, in particular spirulina.

According to the invention, the term “water-soluble compounds” is used to describe compounds that are soluble in water and contained in the microalgae, preferably selected from among the proteins and peptides, water-soluble vitamins, preferably the vitamins of the group B (in particular Thiamin (B1), Riboflavin (B2), Niacin (B3), pantothenic acid (B5), pyridoxine (B6), Biotin (B8), Folate (B9), Cobalamin (B12)), minerals, preferably sodium, calcium, potassium, magnesium and iron, la C-phycocyanin (or phycocyanin), and chlorophyll.

In a preferred manner according to the invention, the water-soluble compound according to the invention is phycocyanin.

The term “long shelf life” is used in the present invention to describe a shelf life of more than 6 months, preferably of more than 12 months.

The term “ambient temperature” as used in the present invention describes a temperature of 25° C.

The term “acidic pH” is used to describe a pH lower than 7. Preferably, the final pH of the drink is between 3 and 5, preferably between 3.5 and 4.5, and even more preferably between 3.8 and 4.2.

The term “fruit juice” according to the present invention is a natural fruit juice or a concentrated fruit juice, preferably reconstituted in water. The fruit can be selected from among all fruits that can be used for human consumption, such as oranges, apples, grape, pineapple, mango, pear, peach, apricot, guava, strawberry, red fruit, banana, raspberry, cranberry, kiwi, and preferably orange.

The term “ingredients of the drink sensitive to heat treatments” according to the present invention is used to describe ingredients known to a person skilled in the art as being conventionally integrated in a foodstuff, such as aromas or vitamins. These ingredients, as well as the extracts of eukaryotic or prokaryotic (cyanobacteria) microalgae and/or of purified water-soluble compounds extracted from eukaryotic or prokaryotic (cyanobacteria) microalgae can be in the form of powders that are diluted in water during the mixing step, or in a highly concentrated and stabilised liquid form.

The term “sterilisation by microfiltration” according to the present invention is used to describe a filtration conducted in a frontal or tangential manner, advantageously on a food filter, for example made of polyamide, in particular nylon, with a mesh thickness of less than 0.5 microns. A pre-filtration step can be performed on a filter of 2 to 50 microns, preferably of less than 25 microns. Preferably, the filtration step is conducted at a constant flow rate, preferably on less than 75% of the volume of the end drink, more preferably on less than 25%, even more preferably on less than 5%, and more preferably still on less than 2%.

The mixture according to the present invention is achieved preferably in mixing vats, using an immersion blender, a food blender, a homogenising tank, or a pneumatic pump.

In a preferred manner according to the invention, the method comprises an additional step of bottling the obtained drink. In a preferred manner, the bottling step is conducting under aseptic conditions.

In a preferred manner according to the invention, the extracts of eukaryotic or prokaryotic (cyanobacteria) microalgae and/or of purified water-soluble compounds extracted from eukaryotic or prokaryotic (cyanobacteria) microalgae represent from 0.01 to 10% by weight of the drink, preferably from 0.01 to 1% by weight of the drink, preferably from 0.01 to 0.02% by weight of the drink.

In a preferred manner according to the invention, the method further comprises a step g) of storing said obtained drink, in darkness, for a period ranging from 24 hours to 7 days, and preferably for 48 hours.

The term “darkness” is used to describe the fact that the storage of said obtained drink is conducted in the absence of light. This storage in darkness improves the preservation of the phycocyanin, of which one indicator is the persistence of the adsorption spectrum thereof at 620 nm. Preferably, the storage in darkness is conducted at ambient temperature.

In a preferred manner according to the invention, the storage step of said drink in darkness enables to preserve 50%, preferably 75%, and even more preferably 90% of the adsorption spectrum at 620 nm of the phycocyanin, 7 days after the bottling thereof (storage in darkness and at ambient temperature).

According to a second aspect, the invention relates to a food drink with a long shelf life at ambient temperature, preferably of more than 6 months, with an acidic pH, preferably made from fruit juice, such as that obtained by the method according to any one of the preceding claims comprising extracts of eukaryotic or prokaryotic (cyanobacteria) microalgae and/or of purified water-soluble compounds extracted from eukaryotic or prokaryotic (cyanobacteria) microalgae.

In a preferred manner according to the invention, the drink according to the invention is still. The term “still” describes the fact that it is not sparkling.

In a preferred manner according to the invention, the drink obtained with the method according to the present invention is a stable drink. The term “stable drink” used in the present invention is used to describe a drink of which the microbiological levels for the non-pathogenic alteration flora remain under target thresholds:

At Production Output
<10 UFC/ml Total mesophilic flora
<10 UFC/ml Total anaerobic flora
<10 UFC/ml Lactic bacteria
<10 UFC/ml yeast/mould

At the End of the Shelf Life
<200 UFC/ml Total mesophilic flora
<200 UFC/ml Total anaerobic flora
<200 UFC/ml Lactic bacteria
<200 UFC/ml yeast/mould

An embodiment of the invention is now described by way of a non-limiting example.

### EXAMPLE

Composition of the Drink:

Mixture a)

| Ingredients | Quantities per 1000 kg | |
|---|---|---|
| Reverse osmosis-purified water | QS | |
| Spirulina extract (purified phycocyanin) | 270 | g |
| Magnesium | 1.3 | kg |
| Maltodextrin | 350 | g |
| Vitamin B2 | 100 | g |
| Vitamin B12 | 2 | g |
| Potassium sorbate | 340 | g |
| Sodium benzoate | 200 | g |

Mixture b)

| Ingredients | Quantities per 1000 kg |
|---|---|
| Reverse osmosis-purified water | 953 kg |
| Concentrated orange juice | 47 kg |

### 2 Equipment

### 2.1 Equipment for the Preparation of the Mixture

For the mixture b), made from orange juice, it was prepared by diluting concentrated orange juice. For this purpose, an immersion blender was used directly in a 1 m³ tank.

For the mixture a), comprising microalgae extract, the preparation requires mixtures of powder and dissolutions of the powder in water. For this purpose, different equipment can be used before the step involving the 1 m³ tank: the immersion blender, a 20 L food blender, a homogenising tank (100 L), a pneumatic pump in a closed circuit on the preparation tank.

### 2.2 the Front Filtering Assembly

The assembly is made of a tank (1 m³) containing the mixture to be filtered, a pump and the filter housing (with the filtering cartridge thereof). The tank is refilled during a test (by transfer from another tank using a pneumatic pump). A valve upstream from the housing can be used to adjust the filtration rate (to keep it constant). The nitrogen cylinder is used for integrity testing.

### 2.3 The Housing and Filtering Cartridges

The housing used in a sanitary Pall housing of the FBT series and fitted with a 10″ cartridge. The cartridges used are Fuente II cartridges, ref. AB1FFN7WH4: these cartridges are made of pleated polyethersulfone (Ultipleat®, double layer pleating), with a filtration threshold of 0.2 μm of sterilising grade. They are certified to come into contact with foodstuffs. Each 10″ cartridge has a filtering surface of 1.04 m².

### 3 Method

3.1 Mixture b)=Made from Orange Juice

For the preparation of the mixture b), made from orange juice, 47 kg of orange juice was poured in the tank, which was filled with water to % full. The tank was then filled with water so as to achieve a mass of 1000 kg. Finally, the mixture was homogenised with the immersion blender. The mixture was then transferred by a pneumatic pump from the preparation tank to the assembly supply tank.

3.2 Mixture a)=Containing the Microalgae Extract

The mixture of the three first powder products was conducted in a dry state using the food blender.

Then, a portion of this powder mixture (400-500 g) was slowly poured into the whirlpool of a tray containing 5-6 L of water; the stirring (by the immersion blender) was performed for approximately 15 minutes. This concentrated mixture is then poured into the 1 m³ tank filled to three quarters with water and the content of the tank was again stirred with the immersion blender. The other powder products were first mixed with water (in the whirlpool) in a concentrated form, and then added to the 1 m³ tank. The liquid products were directly added in the 1 m³ tank. After adding all the products, the content of the 1 m³ tank was homogenised with the immersion blender and by closed-circuit circulation with a pump.

### 3.3. Sterilisation by Microfiltration of the Mixtures

Each mixture a) then b) undergoes microfiltration (a new cartridge is used for each mixture), with the following results:

| | Mixture b) | Mixture a) |
|---|---|---|
| Pressure (bar) | 2 | 2.46 |
| Filtration rate (kg/h/m²) | 769 (constant) | 770 |
| Filtered mass (kg/m³) | 1920 | 790 |
| Filtrate | pH 4 | pH 8.6 turbidity 36 NTU, |
| | | absorbency (620 nm): 0.388 |

3.4: Homogenising the Mixture a) and b)

The mixtures a) and b) sterilised at step 3.3 are mixed and homogenised in a 2 m² tank using a pitched-blade stirring system.

The mixture a) is added first in the homogenising tank.

1. A method for obtaining a food drink with a long shelf life at ambient temperature with an acidic pH comprising eukaryotic or prokaryotic (cyanobacteria) microalgae, and/or purified water-soluble compounds extracted from eukaryotic or prokaryotic (cyanobacteria) microalgae, wherein said method comprises at least:
a. one step of mixing said extracts and/or water-soluble compounds with the ingredients of the drink that are sensitive to heat treatments, said mixture being maintained at a pH greater than 7;
b. one optional step of mixing the ingredients of the drink that are not sensitive to heat treatments with the ingredient or ingredients that have an acidic pH;
c. one step of sterilisation by microfiltration of the mixture obtained at step a);
d. one step of sterilisation by microfiltration or by heat treatment of the mixture obtained at step b) or of the ingredient with an acidic pH;
e. one step of homogenising the sterilised mixtures obtained at steps c) and d); and
f. obtaining a drink with a long shelf life and an acidic pH comprising extracts of eukaryotic or prokaryotic (cyanobacteria) microalgae and/or purified water-soluble compounds extracted from eukaryotic or prokaryotic (cyanobacteria) microalgae.

2. The method according to claim 1, wherein the drink is made from fruit juice, the acid ingredient being natural or concentrated fruit juice.

3. The method according to claim 1, wherein the extracted water-soluble compounds are selected from among proteins and peptides, water-soluble vitamins, C-phycocyanin, and chlorophyll.

4. The method according to claim 1, wherein the eukaryotic microalgae are selected from among Chlorella, Nannochloropsis, Dunaliella and Euglena, and wherein the cyanobacteria are selected from among spirulina (Arthrospira platensis or Spirulina maxima) and AFA (Aphanizomenon Flos-aquae).

5. The method according to claim 1, further comprising an additional step whereby the obtained drink is bottled under aseptic conditions.

6. The method according to claim 1, wherein the extracts of eukaryotic or prokaryotic (cyanobacteria) microalgae and/or of purified water-soluble compounds extracted from eukaryotic or prokaryotic (cyanobacteria) microalgae represent from 0.01 to 1% by weight of the drink.

7. The method according to claim 1, further comprising a step g) whereby said obtained drink is stored in darkness for 24 hours to 7 days.

8. A food drink with a long shelf life at ambient temperature with an acidic pH obtained by the method according to claim 1, comprising extracts of eukaryotic or prokaryotic (cyanobacteria) microalgae and/or of purified water-soluble compounds extracted from eukaryotic or prokaryotic (cyanobacteria) microalgae.

9. The drink according to claim 8, wherein the drink is still.

10. The method according to claim 1, wherein the food drink is made from fruit juice and the shelf life at ambient temperature is more than 6 months, and
wherein in the step of homogenising the sterilised mixtures obtained at steps c) and d), said sterilised mixture obtained at step c) is added prior to the sterilised mixture obtained at step d).

11. The method according to claim 3, wherein the water-soluble vitamins are vitamins from the group B, minerals, including sodium, calcium, potassium, magnesium and iron, and the chlorophyll is phycocyanin.

12. The method according to claim 4, wherein the cyanobacteria is spirulina.

13. The method according to claim 1, wherein the extracts of eukaryotic or prokaryotic (cyanobacteria) microalgae and/or of purified water-soluble compounds extracted from eukaryotic or prokaryotic (cyanobacteria) microalgae represent from 0.01 to 0.5% by weight of the drink.

14. The method according to claim 1, wherein the extracts of eukaryotic or prokaryotic (cyanobacteria) microalgae and/or of purified water-soluble compounds extracted from eukaryotic or prokaryotic (cyanobacteria) microalgae represent 0.01 to 0.02% by weight of the drink.

15. The food drink according to claim 8, wherein the food drink is made from fruit juice.

16. The method according to claim 2, wherein the extracted water-soluble compounds are selected from among proteins and peptides, water-soluble vitamins, C-phycocyanin, and chlorophyll.

17. The method according to claim 2, wherein the eukaryotic microalgae are selected from among Chlorella, Nannochloropsis, Dunaliella and Euglena, and wherein the cyanobacteria are selected from among spirulina (Arthrospira platensis or Spirulina maxima) and AFA (Aphanizomenon Flos-aquae).

18. The method according to claim 3, wherein the eukaryotic microalgae are selected from among Chlorella, Nannochloropsis, Dunaliella and Euglena, and wherein the cyanobacteria are selected from among spirulina (Arthrospira platensis or Spirulina maxima) and AFA (Aphanizomenon Flos-aquae).

19. The method according to claim 2, further comprising an additional step whereby the obtained drink is bottled under aseptic conditions.

20. The method according to claim 3, further comprising an additional step whereby the obtained drink is bottled under aseptic conditions.
